(19) United States
(12) Patent Application Publication
(10) Pub. No.: US 2006/0098866 A1
(43) Pub. Date: May 11, 2006

(54) User interface for inspection system with isoluminant regions

(75) Inventors: Andrea Whitson, Jamaica Plain, MA (US); Shuanghe Shi, Southborough, MA (US); Richard F. Eilbert, Lincoln, MA (US)

Correspondence Address: WOLF GREENFIELD & SACKS, PC;FEDERAL RESERVE PLAZA, 600 ATLANTIC AVENUE, BOSTON, MA, 02210-2206, US

(73) Assignee: L-3 Communications Security and Detection Systems, Inc., Woburn, MA (US)

(21) Appl. No.: 11/114,934

(22) Filed: Apr. 26, 2005

Related U.S. Application Data
(60) Provisional application No. 60/624,761, filed on Nov. 3, 2004.
(60) Provisional application No. 60/565,386, filed on Apr. 26, 2004.
(60) Provisional application No. 60/624,615, filed on Nov. 3, 2004.

(51) Int. Cl. G06K 9/00

(52) U.S. Cl. 382/162

(57) ABSTRACT

An inspection system having a user friendly operator display. Characteristics of items under inspection are represented in the display by color and brightness. Each pixel on the display is assigned an intensity representation of a first characteristic of a region of an item, such as density. Color is assigned to each pixel based on anther characteristic of the regions, such as atomic number. The intensity assigned to each pixel in the display is based in part on the color assigned to that pixel so that each pixel representing the same value of the first characteristic will appear to a human with the same brightness, regardless of the color assigned to the pixels. Such a display is used in an x-ray inspection system to represent attenuation of x-rays by brightness and effective atomic number by color.

### RELATED APPLICATIONS

This application claims priority under 35 U.S.C. § 119(e) to U.S. Provisional Application Serial No. 60/624,761, entitled “USER INTERFACE FOR INSPECTION SYSTEM WITH ISOLUMINANT REGIONS,” filed on Nov. 3, 2004, which is herein incorporated by reference in its entirety. This application also claims priority under 35 U.S.C. § 119(e) to U.S. Provisional Application Serial No. 60/565,386, entitled “X-RAY INSPECTION SYSTEM WITH DISPLAY ALGORITHM TO IMPROVE OPERATOR PERFORMANCE,” filed on Apr. 26, 2004, which is herein incorporated by reference in its entirety. This application also claims priority under 35 U.S.C. § 119(e) to U.S. Provisional Application Serial No. 60/624,615 entitled “IMAGE PROCESSING WITH EDGE DETECTION,” filed on Nov. 3, 2004, which is herein incorporated by reference in its entirety.

### BACKGROUND OF INVENTION

1. Field of Invention

This invention relates generally to inspection systems and more specifically to display of information obtained from an inspection system.

2. Discussion of Related Art

Inspection systems are widely used to detect contraband concealed in items. For example, inspection systems are used at airports to identify explosives, weapons or other contraband in luggage or other parcels. Inspection systems are also used in connection with the inspection of cargo or in other settings, such as at ports or border crossings.

FIG. 1 illustrates an inspection system 100, such as exists in the art for inspecting suitcases, other baggage or carry-on items at airports. Items to be inspected are placed on a moving conveyor 102 that passes the items through a tunnel 104. Within the tunnel, a radiation source generates penetrating radiation that passes through the item under inspection. Detectors, usually positioned in an array, receive radiation from the source after it has passed through the time under inspection. Each detector outputs an indication of the amount of radiation that passed through the item under inspection. Because the radiation emitted by the source is generally known, the outputs of the detectors may also be taken as an indication of the amount the item under inspection attenuated the radiation.

The output of each detector provides information about a region of the item under inspection between the detector and the radiation source. To represent the item under inspection, multiple detector outputs are processed into an image that is, in many systems, displayed for a human operator to observe. The output of each detector is used to set the visual characteristics of a pixel on a display screen that represents a corresponding region of the item under inspection. For example, the intensity of each pixel may be set in proportion to the attenuation indicated by the output of a detector. Because different types of materials attenuate radiation by different amounts, an image formed from the detector outputs can provide a human operator visual clues about objects in the item under inspection. For example, a metal gun, even if concealed inside an item under inspection, may give rise to an area of pixels with an appearance indicating a relatively high attenuation with a shape a human operator can recognize as a gun.

To further assist an operator recognize contraband objects, other characteristics of the item under inspection may be used to control other properties of the pixels that form the display. For example, dual energy inspection systems may measure the effective atomic number of regions of the item under inspection. Often, information about the effective atomic number of a region is represented by color of a corresponding pixel in the image. By studying the shape and color of an area in the image, the operator may more effectively identify the nature of objects within the item under inspection.

The image formed by inspection system 100 may be presented directly to a human operator. Alternatively, the image may be analyzed by a computer first, with the results of computerized processing then presented to a human operator.

FIG. 1 shows an operator station 110, that may include a computer processor that collects data from detectors in inspection system 100 and forms an appropriate image. Operator station 110 includes a display 112 on which images may be displayed for an operator to view. Operator station 110 also includes an input device 114 through which the operator may provide inputs to control either inspection system 100 or the appearance of images on display 112.

It would be desirable to have a user interface that presents images of items under inspection in such a way that objects contained within the item appear in the image and can be easily analyzed by a human operator.

### SUMMARY OF INVENTION

In one aspect, the invention relates to a method of operating an inspection system. The method includes determining at least a first characteristic and a second characteristic for each of a plurality of regions in an item under inspection. For each of the plurality of regions, a color value is assigned based on a value of the first characteristic determined for the region and an intensity value based on a value of the second characteristic determined for the region and the color value assigned to the region. An image of the item under inspection containing a plurality of pixels is displayed, with each pixel having the assigned color and intensity value for at least one region of the plurality of regions.

In another aspect, the invention relates to an inspection system. The inspection system includes a data acquisition system that acquires, for each of a plurality of regions in an item under inspection, a plurality of measurements indicative of radiation passing through the region and effective atomic number of material in the region. A processor coupled to the data acquisition system receives, for each of the plurality of regions, the plurality of measurements. A display having a plurality of pixels and an input is coupled to the processor so that it may receive at least one control input controlling the plurality of pixels. Computer-readable medium is also coupled to the processor so that it may hold computer-executable instructions for mapping, for each region, the plurality of measurements to control values for a pixel of the display, the mapping using a color-dependent relationship between the plurality of measurements and intensity to produce a set of control values representative of an image of an item under inspection. The system also includes computer executable instructions for generating the at least one control signal.

In yet a further aspect, the invention relates to a computer-readable medium having a plurality of computer-executable instructions. The computer-executable instructions, for each of a plurality of regions of an item under inspection, control a computer to receive at least two measured values indicative of attenuation of penetrating radiation through the region; assign a color value based on the at least two measured values for the region and an intensity value based on at least one of the at least two measured values for the region and the color value assigned to the region; and display an image of the item under inspection containing a plurality of pixels, with each pixel having an appearance based on the assigned color and intensity value for at least one region of the plurality of regions.

### BRIEF DESCRIPTION OF DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1 is a sketch of an inspection system as known in the prior art;

FIG. 2 is a sketch of an image of an item under inspection;

FIG. 3A is a graph depicting a mapping between attenuation measurements and characteristics of a region of an item under inspection;

FIG. 3B is a mapping between characteristics of a region of an item under inspection and parameters to control a display; and

FIG. 4 is a sketch, in block diagram form, of a portion of an inspection system incorporating the mapping of FIGS. 3A and 3B.

### DETAILED DESCRIPTION

This invention is not limited in its application to the details of construction and the arrangement of components set forth in the following description or illustrated in the drawings. The invention is capable of other embodiments and of being practiced or of being carried out in various ways. Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

According to an embodiment of the invention, an inspection system may be improved by presenting images of items under inspection in a way that facilitates detection and recognition of objects by a human operator. Improving the image may directly result in increased recognition or detection of contraband items by the operator. In addition, improving the image may reduce operator fatigue, which further reduces the chance of operator error and increases the likelihood that contraband items will be correctly recognized.

The images may be generated from measurements indicating characteristics of an item under inspection. These measurements may be made with any suitable inspection system, such as an inspection system that uses penetrating radiation to acquire information about an item under inspection. Systems that use penetrating radiation, such as x-rays or gamma rays, may be used. The process for producing a display also may be used in connection with image information acquired with other types of inspection systems, such as those that use reflected radiation to ascertain characteristics of an item under inspection.

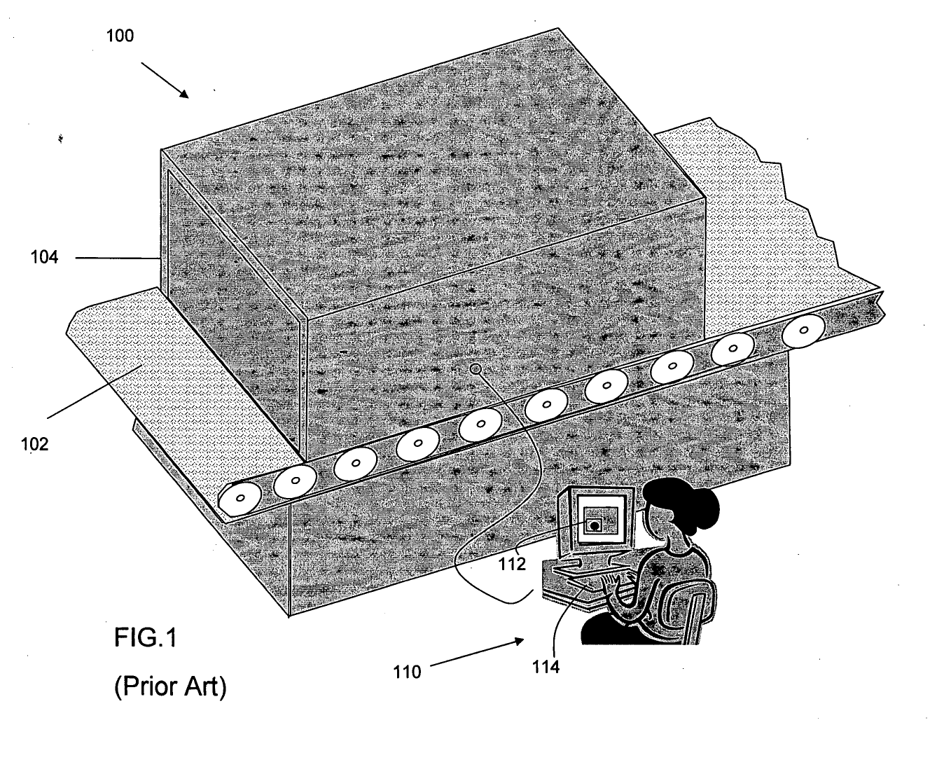

Here, inspection system 100 (FIG. 1) is used as an example of a system in which the invention may be applied. In such an exemplary embodiment, the improved image may be displayed on display 112 associated with an operator station. Display 112 may be a CRT, TFT, plasma, DLP, LCD or any other suitable form of display. In the embodiments described herein, display 112 is a color display. However, neither the form of the inspection system used to gather data on an item under inspection nor the form of the display on which the image is presented is a limitation on the invention.

In one embodiment, the image is improved using a process of mapping measurements that indicate characteristics of an item under inspection to display characteristics. According to the process, the intensity and color of pixels on the display are controlled to create an improved image.

In the exemplary embodiment in which the process is applied in connection with an inspection system 100, the process may be implemented as a software program stored on a computer-readable medium and running on a computer that is part of an operator station 110 of an inspection. However, the process may be performed on any suitable processor, regardless of location. For example, the process may be performed on a processor connected to the inspection system over a network or otherwise remote from inspection system 100.

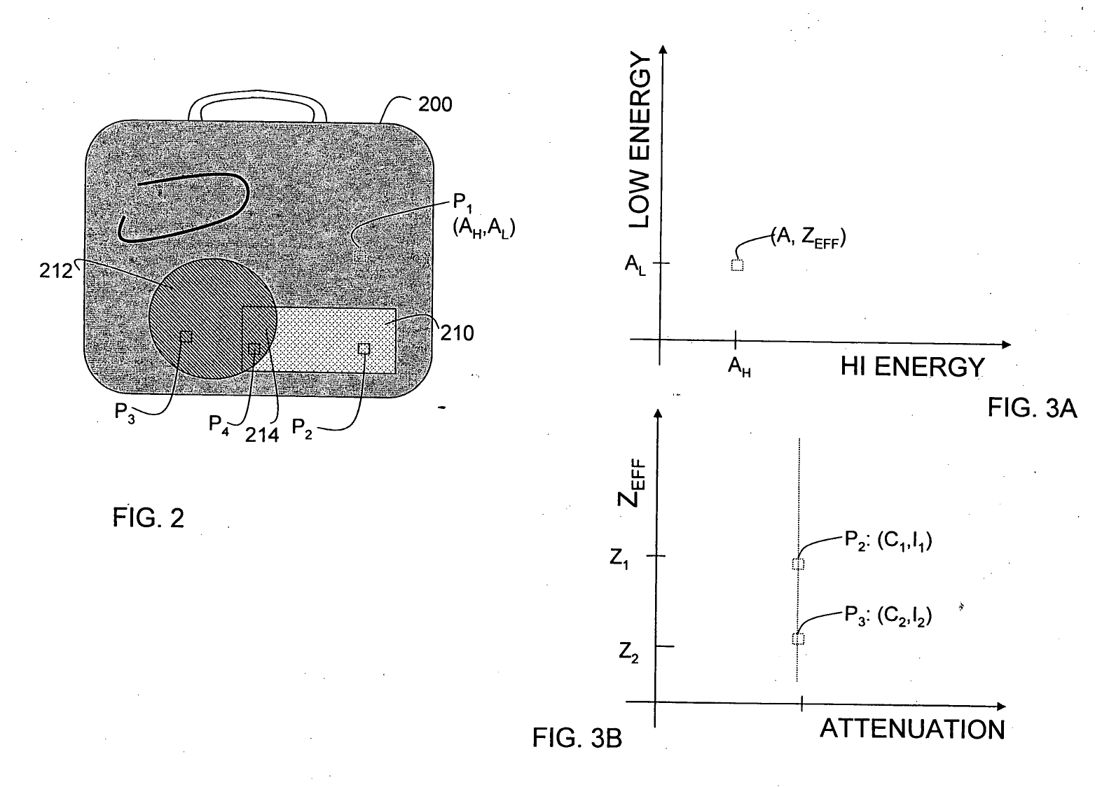

FIG. 2 shows an image of an item under inspection, such as a suitcase 200. In this example, the image reveals that various objects are inside suitcase 200. Objects such as 210 and 212 are shown. In use, an inspection system may present an image of an item under inspection in a fashion that allows a user to identify easily whether objects 210 and 212 contained within the item represent contraband such as weapons, drugs or other illegal items. The operator may use various visual clues in the image, such as shape, luminance or color of areas in the image, to identify contraband.

When suitcase 200 passes through inspection system 100, detectors within inspection system 100 generate measurements that allow characteristics of regions of suitcase 200 to be determined. In the example used herein, inspection system 100 is a projection x-ray system that forms a two dimensional image representing a projection through suitcase 200. Measured characteristics for each region in the item under inspection are reflected as a pixel in the displayed image. The visual properties of the pixel are set based on the measured characteristics of the region of the item under inspection.

In the example, the detectors are laid out in a regular array and every region of the item under inspection that is projected onto a detector is represented by a pixel in an image formed from the outputs of the detectors. The size and spacing of regions of the item under inspection that correspond to each pixel on the display will depend on the type, size and positioning of detectors within the inspection system as well as other factors, such as the relative positioning of the source, item under inspection and the detector array.

The detectors may form an array that runs transverse to the direction of travel of conveyor 102. Such an array may be smaller than the item under inspection. To image the full item under inspection, multiple samples of the outputs of the detectors in the array may be collected as the item under inspection is moved past the array on conveyor 102. A data acquisition system may assemble these multiple samples into an array of values that duplicate the effect of taking measurements of all regions of the item under inspection at one time with a larger array. Other scanning techniques may also be used to take measurements on an item under inspection. For example, detector array could be moved past a stationary item. The specific method by which measurements are taken is not a limitation of the invention.

The display may be formed with a regular array of pixels. The size and spacing of pixels on the display may depend on characteristics of the display device. The full array of pixels is not identified in FIG. 2. Rather a small number of pixels are identified to illustrate the mapping of measurements taken by an inspection system to display characteristics presented on an operator display.

In the present example, the inspection system is a dual energy x-ray system. In a dual energy x-ray system, the item under inspection is exposed to x-rays of at least two energies. Two attenuation measurements are taken for each region of the item under inspection, one at each energy level. These dual energy measurements allow multiple characteristics of an item under inspection may be determined. For example, the density and thickness of in a region of the item under inspection 200 may impact the total attenuation of x-rays following that path. Thus, attenuation information, at either energy, measured for a region of the item under inspection, provides information about a characteristic of that region.

The relative values of attenuation of radiation at different energy levels may be used to provide information about the effective atomic number of objects along that path. Materials of low atomic number provide relatively small attenuation to both high and low energy x-rays. In contrast, materials of relatively high atomic number provide significant attenuation to low energy x-rays with less attenuation to higher energy x-rays. By comparing, for a region of the item under inspection, the attenuation at low and high energies, an indication of the effective of atomic number of material in that region may be determined. Processing of dual energy x-rays to generate information about effective atomic number is known in the art and any suitable method, whether now known or hereafter developed, may be used to generate information about effective atomic number.

The visual characteristics for each pixel in the image formed by the inspection system 100 may be based on two or more characteristics of a corresponding region of the item under inspection. In one embodiment, one of the characteristics is attenuation of the region, or a second characteristic may be effective atomic number of the region. In setting the visual properties of pixels in the display image for an operator, it is desirable to provide display modes in which information about both attenuation and effective atomic number may be visible. For example, pixel P₁ is illustrated as corresponding to a region having values A_{H} and A_{L} associated with it. These values represent the measurements indicating attenuation of x-rays at a higher energy level and a lower energy level, respectively.

Either the value of A_{H} or A_{L} may be taken as the attenuation of the region. Though, any suitable way for determining an attenuation from multiple measured levels of radiation may be used, such as using a combination of the values A_{H} and A_{L} to compute attenuation

The attenuation of a region in the measured image may be presented to the operator represented in the image by controlling the brightness of a corresponding pixel in the display image. Simultaneously, information on the effective atomic number of a region in the measured image item under inspection may be presented to the operator by controlling the color or hue of a pixel in an image of the item under inspection.

FIG. 3A shows that attenuation measurements for high energy and low energy radiation may be converted to an overall attenuation value and an effective atomic number value. This conversion may be performed for each region of the item under inspection. Such a conversion process is known in the art. Any suitable method for converting x-ray measurements into attenuation and effective atomic number values, whether now known or hereafter developed, may be used. These values may then be used to set properties for pixels on the display corresponding to each region.

FIG. 3B illustrates a manner in which multiple material characteristics, such as attenuation and effective atomic number, may be mapped to parameters that control a pixel of a display, such as display 112. Commands sent to the display control the display appearance. The commands may be provided in any suitable format. For example, the display may receive input commands in the form of color and intensity values for each pixel. Other color encoding schemes are known and the invention is not limited to any specific color encoding scheme.

Information represented by color and intensity in an image on the display will be perceived by a human operator observing the display. However, the perception of the human operator is impacted by the human visual system. For example, the human visual system is more sensitive to light of some colors than of other colors. As a result, light of two different colors, each with the same intensity, may be perceived by a human user to be of different brightness levels.

As used herein, the term “intensity” refers to the amount of light energy that is emitted by the display. “Luminance” is used to refer to a human user's perception of brightness of light. Light of two different colors may have the same intensity but different luminance. Thus, commands sent to a display indicating that two pixels should have the same intensity though different colors may create pixels on the display that appear different to a human user. Using color information to represent one characteristic of an item under inspection has the potential to distort information about another characteristic presented through the use of intensity information.

To ensure that superimposing color information on information represented by intensity does not distort the information represented by intensity, the intensity of the light emitted by each pixel of the display may be altered based on the color assigned to the pixel. For example, FIG. 3B illustrates a mapping of color and intensity to two pixels denoted P₂ and P₃. In the example of FIG. 2, pixels P₂ and P₃ represent values measured at regions within two objects, objects 210 and 212, respectively. In this example, objects 210 and 212 attenuate x-rays by the same amount. However, they are made of materials with different atomic numbers. As a result, it is desirable that pixels P₂ and P₃ appear on the user display 112 with different colors reflecting different atomic numbers. Nonetheless, the pixels should appear to the user with the same luminance. To ensure that the pixels have the same luminance, it may be necessary to assign a different intensity to each of pixels P₂ and P₃ so that the display outputs light with a higher intensity for colors to which human eyes are less sensitive.

In this example, object 210 is shown having an effective atomic number of Z₁. Accordingly, pixels corresponding to regions within object 210, such as pixel P₂, are mapped to a color C₁ corresponding with Z₁. Object 212 is shown to have an effective atomic number of Z₂. Pixels corresponding to regions within object 212, such as pixel P₃, are shown to be mapped to a color C₂. Even though pixels P₂ and P₃ are shown to provide similar attenuation to x-rays, pixel P₂ is assigned an intensity value I₁ and pixel P₃ is given an intensity value I₂. In the example, pixel P₂ has a higher intensity value than pixel P₃. Such a mapping reflects that the human eye is more sensitive to color C₂ than to color C₁.

Each person may have different sensitivity to colors. To customize a display for an operator, the mapping from an attenuation value to an intensity value applied to the display may be different for each operator. An appropriate mapping may be determined empirically, such as by having the operator observe regions on a display of different colors. The operator may indicate regions of different color that appear with the same luminance or the operator may adjust the intensity of regions of different colors so that they appear with the same brightness. From this operator input, the operator's sensitivity to different colors may be determined.

Alternatively, standardized data may be used to determine appropriate mapping. Data has been collected to represent the average human response to various colors. For example, data exists representing a CIE standard observer. Such data indicates how an average human user perceives different colors presented by different types of display devices. An inspection system may be programmed to apply a mapping between an attenuation value and an intensity value based on average data for human users on the type of display used for that system.

FIG. 2 shows that objects such as 210 and 212 appear as regions of generally uniform properties. Raw data collected by an inspection system may be preprocessed before color is assigned to each pixel to increase the likelihood that collections of pixels corresponding to objects within an item under inspection appear as regions of generally uniform characteristics. For example, image smoothing techniques may be applied. Image smoothing has the effect of creating regions that are more uniform in appearance. Additionally, edge enhancement, region growing and other suitable image enhancement process may be used to improve the quality of the image displayed. Such image processing may be applied before or after the pixels of the image are mapped to specific colors.

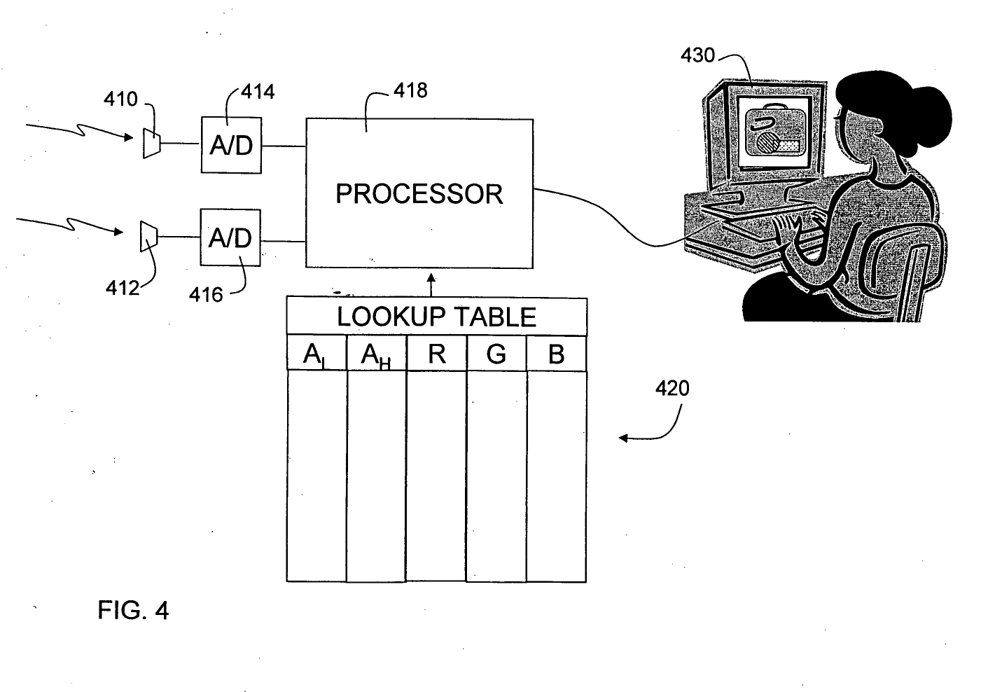

FIG. 4 shows in block diagram form a portion of an inspection system employing a mapping similar to that illustrated in connection with FIGS. 3A and 3B. FIG. 4 shows two detectors 410 and 412. In this embodiment, both detectors are used to measure properties of the same region of an item under inspection. Detector 410 is sensitive to radiation at a lower energy and detector 412 is sensitive to radiation at a higher energy. The output of each detector is converted to digital form. Here analog to digital converters 414 and 416 are shown converting the outputs of detectors 410 and 412, respectively, to digital form. The digital values representing a measured value of detected radiation are applied to a processor 418. Processor 418 may be a processor connected to and controlling an inspection system or may be a processor located remotely from the inspection system. In the illustrated embodiment, processor 418 accesses computer readable medium programmed with a look-up table 420. The look-up table 420 may be indexed by values indicating multiple characteristics of an item under inspection. In this example, the values measured by detectors 410 and 412 are used directly as an index to look-up table 420 to select one of the locations in look-up table 420. The indexed location contains control values for display 430. It is not necessary that the mapping from measured values to pixel values on the display screen occur in multiple steps as explained in connection with FIG. 3A and FIG. 3B. Rather, measured values may be converted directly to values controlling a display such as display 430.

Displays used in connection with computerized equipment often receive three control values per pixel. The control values are identified as R, G, and B. Each control value specifies the intensity of a primary color emitted by a pixel. In the example, the primary colors are red, green, and blue. Specifying the intensities of each of the primary color components specifies the displayed color for the pixel as well as the intensity. In operation, processor 418 receives values of low and high attenuation measurements for each region of the item under inspection and converts each pair of measured values to control parameters for a pixel of display 430 by reading a value from look-up table 420.

In this embodiment, the lookup table is programmed with R, G, and B control values that reflect isoluminant mapping as described in connection with FIGS. 3A and 3B. In this example, any combination of attenuation values A_{L} and A_{H} that indicates the same attenuation have assigned to them R, G, and B control values that produce a pixel on display 430 that will appear with the same brightness to a human operator. As a result, multiple characteristics of the item under inspection are more accurately displayed in a form that facilitates identification of contraband items.

Having thus described several aspects of at least one embodiment of this invention, it is to be appreciated various alterations, modifications, and improvements will readily occur to those skilled in the art.

For example, FIG. 4 shows separate detectors for high and low energy x-rays. A single detector sensitive to high and low energy radiation may be used in connection with pulsed x-ray sources that alternately emits high and low energy radiation.

Further, FIG. 4 shows an input signal path for a single region of an item under inspection. Often, inspection systems include multiple detectors in an array to allow data values for multiple pixels in the measured image to be simultaneously obtained. Where the size of the array of detectors is smaller than the item under inspection, either the array of detectors or the item under inspection may be moved so that the detector array may scan across the entire item being inspected.

Also, it is described that an image is displayed for the operator on screen 430 using a predetermined mapping between attenuation and luminance. However, it is sometimes desirable to allow the operator to adjust either the brightness or contrast of the display. The mapping between each attenuation level and specific luminance level may be variable. For example, processor 418 may be programmed with multiple lookup tables with the specific lookup table used being selected in response to a user input.

Further, it is not necessary that the mapping between a measured property, such as attenuation, and a display property, such as luminance, be linear. Because a human eye is sensitive to differences over a limited range of luminance values, it may be desirable to map a range of attenuation values that are expected to reveal objects of interest in an image to luminance values in the range over which the human eye is most sensitive to differences. As a result, features of interest may appear with relatively high contrast in the image.

Furthermore, it is described that each pair of measured values A_{L} and A_{H} is mapped to a set of control values for a pixel on display 430. It is not necessary that each combination of measured values be mapped to a different set of control values. It may be desirable that combinations of measured values indicating regions of similar characteristics be mapped to control values that create an identical appearance on the display. Providing such a many to one mapping may provide a form of image smoothing so that regions representing objects in the image appear more uniform.

Also, it is not necessary that the inspection system generate a measured image reflecting a two-dimensional projection of an item under inspection. As one alternative, the inspection system may be a CT system that computes a representation in three dimensions of objects within the item under inspection. In this example, the operator display may use intensity and color information to display thickness and effective atomic number for objects. Accordingly, the characteristics of objects that may be displayed according to the invention are not limited to attenuation and effective atomic number as described in the above examples.

A mapping from effective atomic number and attenuation to color and intensity is described above. As a further variation, this mapping may be made in any number of steps, including by combing the mapping step with other computation steps. For example, a mapping could be made to an intensity in one step and then adjusted based on assigned color in another step. Alternatively, both intensity and effective atomic number may be determined from measured attenuation at two different energies. The mapping may be performed directly from the measured energy levels output by detectors receiving radiation passing through a region of the item under inspection to a color and intensity such that the computation of attenuation and intensity is an inherent step of making the mapping.

As another example, measurements of radiation passing through a region of the item under inspection may be adjusted prior to use in preparing a display. Adjustments may be made for detector-to-detector variation or other factors that may influence the value output by one or more detectors. In addition, measurements may be adjusted for beam hardening, to enhance contrast or by processing as otherwise is appropriate in a specific embodiment. Further, the measurements may be adjusted by comparison to a reference value to normalize attenuation measurements. As described herein, measurements for the purposes of producing an image on a display include measurements without adjustment or adjusted measurements.

Further, embodiments are described in which control values for individual pixels are provided in digital form. It is not necessary that the display be a digital display or that the display contain physical structure bounding each pixel. Control values for each pixel could be converted to one or more analog signals that control characteristics of an image on a display. For example, a CRT may receive multiple analog signals that control the intensity of one or more electron beams that scan across a screen. Each control value influences the magnitude of one of the analog control signals during a specific period of time and therefore controls the appearance of a small area of the display, which may be regarded as a “pixel.”

Such alterations, modifications, and improvements are intended to be part of this disclosure, and are intended to be within the spirit and scope of the invention. Accordingly, the foregoing description and drawings are by way of example only.

What is claimed is:

1. A method of operating an inspection system, comprising:
determining at least a first characteristic and a second characteristic for each of a plurality of regions in an item under inspection;
for each of the plurality of regions, assigning a color value based on a value of the first characteristic determined for the region and an intensity value based on a value of the second characteristic determined for the region and the color value assigned to the region; and
displaying an image of the item under inspection containing a plurality of pixels, with each pixel having the assigned color and intensity value for at least one region of the plurality of regions.

2. The method of claim 1, wherein assigning an intensity value comprises assigning an intensity value such that regions having similar values for the second characteristic and different values of the first characteristic appear to a human user to be of the same brightness.

3. The method of claim 1,
additionally comprising measuring for each of the plurality of regions, an attenuation and an effective atomic number; and
wherein assigning a color value based on a first characteristic comprises assigning a color value based one a measured effective atomic number; and
assigning an intensity value based on a second characteristic comprises assigning an intensity value based on a measured attenuation.

4. The method or claim 3, wherein displaying an image of the item under inspection comprises displaying an image of a projection of the item under inspection.

5. The method or claim 3, wherein displaying an image of the item under inspection comprises displaying an image of a slice of the item under inspection computed using tomographic reconstruction.

6. The method of claim 1, additionally comprising receiving from a user a parameter relating to contrast, and, re-assigning for each of the plurality of regions, an intensity value based on the value of the second characteristic for the region, the color value assigned to the region and the parameter relating to contrast.

7. The method of claim 1, wherein assigning an intensity value and assigning a color value for a region comprises assigning control values for a pixel on a display device.

8. The method of claim 7, wherein assigning control values for a pixel comprises assigning an intensity value for each of a plurality of base colors.

9. The method of claim 8, wherein assigning an intensity value for each of a plurality of base colors comprises assigning an intensity value for each of the colors red, blue and green.

10. An inspection system, comprising:
a data acquisition system that acquires, for each of a plurality of regions in an item under inspection, a plurality of measurements indicative of radiation passing through the region and an effective atomic number of material in the region;
a processor coupled to the data acquisition system to receive, for each of the plurality of regions, the plurality of measurements;
a display having a plurality of pixels and an input, coupled to the processor, adapted to receive at least one control signal controlling the plurality of pixels;
computer-readable medium coupled to the processor, the computer-readable medium having computer-executable instructions for:
mapping, for each region, the plurality of measurements to control values for a pixel of the display, the mapping using a color-dependent relationship between the plurality of measurements and intensity, to produce a set of control values representative of an image of an item under inspection; and
generating the at least one control signal from the set of control values.

11. The inspection system of claim 10, additionally comprising:
a conveyor adapted to move items under inspection through the inspection system;
a radiation source positioned to direct radiation at items on the conveyor; and
a plurality of detectors positioned to receive radiation from the radiation source after passing through an item on the conveyor.

12. The inspection system of claim 10, wherein the inspection systems is a CT system.

13. The inspection system of claim 10, additionally comprising a plurality of detectors coupled to the data acquisition system, with a first portion of the plurality of detectors sensitive to radiation at a first energy level and a second portion of the plurality of detectors sensitive to radiation at a second energy level.

14. A computer-readable medium having a plurality of computer-executable instructions for:
for each of a plurality of regions of an item under inspection: receiving at least two measured values indicative of attenuation of penetrating radiation through the region;
assigning a color value based on the at least two measured values for the region and an intensity value based on at least one of the at least two measured values for the region and the color value assigned to the region; and
displaying an image of the item under inspection containing a plurality of pixels, with each pixel having an appearance based on the assigned color and intensity value for at least one region of the plurality of regions.

15. The computer-readable medium of claim 14, further having a data table, wherein assigning a color value and an intensity value for a region comprises reading a plurality of values from a location in the table indicated by the at least two measured values for the region.

16. The computer-readable medium of claim 15, wherein reading a plurality of values from a location in the table comprises reading a plurality of control values, each control value representative of an intensity of a color.

17. The computer-readable medium of claim 15, wherein the computer-readable medium further has a plurality of computer-executable instructions for:
for each of the plurality of regions, presenting the plurality of control values to a display device, thereby controlling the appearance of a pixel on the display device.

18. The computer-readable medium of claim 15, wherein the table comprises a plurality of locations, each storing a plurality of control values, each control value representative of an intensity of a color of light emitted by a pixel.

19. The computer-readable medium of claim 18, wherein the plurality of control values comprise control values representative of the intensity of each of the colors red, green and blue.

20. The computer-readable medium of claim 15, wherein the data table has a plurality of locations, each storing a plurality of values and each indexed by a combination of the at least two measured values.

21. The computer-readable medium of claim 20, wherein the plurality of values stored at each location in the data table are assigned values such that combinations of the at least two measured values indicating the same attenuation index locations that hold values that control the display to present pixels of the same luminance.
